(19) United States
(12) Patent Application Publication
(10) Pub. No.: US 2026/0269488 A1
(43) Pub. Date: Sep. 10, 2026

(54) ANTENNA ARRAY AND METHOD FOR PRODUCING IT

(71) Applicants: Fraunhofer-Gesellschaft zur Förderung der angewandten Forschung e.V., Muenchen (DE); NGK Insulators, Ltd., Nagoya (JP)

(72) Inventors: Ivan NDIP, Berlin (DE); René GOLINSKE, Berlin (DE); Uwe MAAß, Berlin (DE); Alexander GÄBLER, Berlin (DE); Wojciech PARTYKA, Berlin (DE); Kentaro TANI, Nagoya (JP); Jungo KONDO, Nagoya (JP); Makato IWAI, Kronberg im Taunus (DE); Shoichiro YAMAGUCHI, Nagoya (JP); Naotake OKADA, Nagoya (JP); Masato TOKAI, Nagoya (JP)

(73) Assignees: Fraunhofer-Gesellschaft zur Förderung der angewandten Forschung e.V., Muenchen (DE); NGK Insulators, Ltd., Nagoya (JP)

(21) Appl. No.: 19/558,505

(22) Filed: Mar. 6, 2026

(30) Foreign Application Priority Data
Mar. 7, 2025 (DE) 102025108707.5

(51) Int. Cl. H01Q 21/06; H01Q 21/00

(52) U.S. Cl. CPC H01Q 21/065; H01Q 21/0087

(57) ABSTRACT

An antenna array and a method for producing it are disclosed. The antenna array has a first substrate made of an inorganic material, a gas-filled cavity formed in a first main surface of the first substrate and extending into the first substrate in the direction of a second main surface of the first substrate, which is opposite the first main surface, wherein a conductive layer is arranged on a bottom and a side wall of the gas-filled cavity, a second substrate made of a non-conductive inorganic material, which is arranged above the first main surface of the first substrate, and a plurality of antenna elements arranged on a main surface of the second substrate facing away from the first substrate such that at least one antenna element of the plurality of antenna elements is arranged above the gas-filled cavity.

### CROSS-REFERENCE TO RELATED APPLICATION

This application claims priority from German Application No. 10 2025 108 707.5, which was filed on Mar. 7, 2025, and is incorporated herein by reference in its entirety.

### TECHNICAL FIELD

The present invention relates to antennas, in particular to antenna arrays for being used in the higher frequency range, for example at extremely high frequencies (EHF) or at very high frequencies (VHF), such as, for example, in the millimeter wave band (mm-wave band) or sub-terahertz band (sub-THz band). Embodiments relate to antenna arrays with a sufficiently high bandwidth and a sufficiently high gain for being used with such frequencies.

### BACKGROUND OF THE INVENTION

Radio frequency systems, for example mobile radio systems and radar systems, for example radar sensor systems, use antennas whose development in recent decades has been directed towards an improved bandwidth in order to achieve a larger channel capacity in wireless communication systems or a larger resolution in radar systems by means of a larger bandwidth. Since lower frequencies or frequency bands are occupied by many wireless services, the development in wireless systems is towards operation at higher frequencies, for example in the mm-wave band or sub-THz band, due to the enormous bandwidth available in these higher frequency bands. However, the development of wireless systems for operation at mm-wave and sub-THz frequencies is challenging, for example due to the extremely high signal losses at these frequencies. These losses comprise intra-system losses and inter-system losses. The inter-system losses comprise free-space attenuation, atmospheric losses as well as additional losses, e.g. due to obstacles. In particular, the free-space attenuation limits the range of the signals considerably and thus also the applications of wireless communication systems and radar sensor systems at such frequencies.

One approach to at least reduce the inter-system losses and thereby improve the system behavior is to use efficient antennas with high gain. Such antennas are to have a high impedance bandwidth in order to be able to utilize the enormous bandwidth available at the mentioned frequencies. The bandwidth, the efficiency and the gain of the antenna depend strongly on their configuration as well as on the materials used for producing the antenna, for example for the housing of the antenna. In the known technology, so-called cavity-backed antennas are used for high-frequency bands, such as are described, for example, in references [1] to [20]. These known cavity-backed antenna structures can be divided into the following groups:
Group I: References [1], [3], [4], [9], [12] and [15] describe cavity-backed antennas with one or more antenna elements which are formed on a surface of a substrate in which the cavity is also arranged. The cavity is arranged below the antenna element, opens in a direction away from the antenna element and is filled with air. In such antennas, the substrate comprises, for example, a first main surface on which the antenna element is arranged, and a second main surface which is opposite the first main surface. In the second main surface, a recess is formed which extends from the second main surface into the substrate in the direction of the first main surface, but without penetrating the substrate so that a cavity is formed below the antenna element, which is filled with air and the opening of which faces away from the antenna element.
Group II: References [5], [8] and [20] describe cavity-backed antennas with one or more antenna elements which are formed on a surface of a substrate in which the cavity is also arranged. The cavity is arranged below the antenna element, opens in the direction away from the antenna element and is partially or completely filled with a dielectric material. In such configurations, a recess which extends into the substrate and does not penetrate the substrate completely is formed in a first main surface of a substrate. The recess is filled with the dielectric material and the antenna element is located above the first main surface of the substrate and above the filled cavity.
Group III: References [6], [11] and [14] describe cavity-backed antennas with one or more antenna elements, with a cavity which is open towards the antenna element and is formed in a metal substrate. In such structures, a metal substrate is provided which comprises a recess which is filled, for example, with air. Above the recess, there is an insulation layer on which, in turn, the antenna element is located above the opening of the cavity.
Group IV: References [13] and [16] describe cavity-backed antennas with one or more antenna elements which are formed on a surface of a substrate in which the cavity is also arranged. The cavity is arranged below the antenna element, opens in the direction of the antenna element, is filled with air and is surrounded by vias.
Group V: References [10], [17], [18] and [19] describe antenna structures in which the antennas are either formed by slot antennas, are suspended above a cavity or are placed above a substrate by a support structure.

An examination of the above-mentioned antenna structures by the inventors of the present application has shown that these structures are not sufficient with regard to the achievable bandwidth, the achievable efficiency and the achievable gain in order to be used, for example, in communication systems or radar sensor systems which operate in the mm-wave band or in the sub-THz range. Furthermore, the antennas are sensitive to changes in the ambient temperature and humidity.

Starting from the above-mentioned conventional technology, the object underlying the present invention is to provide an antenna array and a method for producing it which provides a high bandwidth and a high gain for operation at higher frequencies, for example in the mm-wave band and in the sub-THz range.

### SUMMARY

According to an embodiment, an antenna array may have: a first substrate made of an inorganic material, a gas-filled cavity formed in a first main surface of the first substrate and extending into the first substrate in the direction of a second main surface of the first substrate, which is opposite the first main surface, wherein a conductive layer is arranged on a bottom and a side wall of the gas-filled cavity, a second substrate made of a non-conductive inorganic material, which is arranged above the first main surface of the first substrate, and a plurality of antenna elements arranged on a main surface of the second substrate facing away from the first substrate such that at least one antenna element of the plurality of antenna elements is arranged above the gas-filled cavity.

According to another embodiment, a method for producing an antenna array may have the steps of: generating a recess in a first main surface of a first substrate made of a non-conductive material so that the recess extends into the first substrate in the direction of a second main surface of the first substrate, which is opposite the first main surface, arranging a conductive layer on a bottom and a side wall of the recess, arranging a second substrate made of a non-conductive material on the first main surface of the first substrate so that the recess is covered and a closed gas-filled cavity is generated, and arranging a plurality of antenna elements on a main surface of the second substrate facing away from the first substrate such that at least one antenna element of the plurality of antenna elements is arranged above the gas-filled cavity.

The present invention thus provides an antenna array which has a sufficient efficiency, in particular a sufficiently large bandwidth as well as a sufficiently high gain for being used in the mm-wave band and in the sub-THz range, for example in the D-band. Compared to the structures known in the conventional technology, the structure according to the invention is advantageous since the required bandwidth and the required gain are achieved in a simple manner by providing an antenna array with at least two antenna elements, at least one of which is arranged above a gas-filled or air-filled cavity. The cavity is formed in a first substrate. The antenna elements are formed on a second substrate which is arranged above the first substrate. The cavity is formed in a first main surface of the first substrate and opens in the direction of the second substrate, i.e. in the direction of the antenna elements. A conductive layer is formed from the bottom and the side wall of the cavity.

Compared to the antenna structures known in the conventional technology, the structure according to the invention has the following advantages:
When compared to the antenna structures known in the conventional technology, in which an air-filled opening is provided below the antenna elements but extends in a direction away from the antenna elements (Group I), and to the antenna structures in which the antenna is arranged above a cavity which is open in the direction of the antenna elements but is filled with a dielectric (Group II), the inventive approach is advantageous since a higher bandwidth and a greater stability of the frequency behavior are made possible by less expansion in the case of temperature fluctuations.
When compared to the antenna structures known in the conventional technology, in which a cavity which is open towards the antenna elements is formed in a metal substrate (Group III), the inventive approach is advantageous since it has a higher accuracy when producing the cavity, a lower temperature sensitivity due to thermal expansion and a lower surface roughness of the cavity.
When compared to the antenna structures known in the conventional technology, in which cavities which are open in the direction of the antenna elements are provided and are surrounded by vias (Group IV), the inventive approach is advantageous since it has less coupling between the cavities and a higher mechanical stability.
When compared to the other known antenna structures mentioned above (Group V), the inventive approach is advantageous since it has a higher strength to mechanical stress.

Advantageous embodiments of the present invention are defined in the sub-claims.

According to embodiments, one or more antenna elements comprise one or more slots for adjusting one or more properties of the antenna array, e.g. a bandwidth.

According to embodiments, the antenna elements are each formed by a conductive structure having a same or different shape and/or dimension.

According to embodiments, the antenna elements comprise a dipole antenna and/or a patch antenna, e.g. a polygonal, round or oval patch antenna.

According to embodiments, the at least one antenna element is configured such that the at least one antenna element and the gas-filled cavity overlap at least partially in plan view.

According to embodiments, at least one antenna element has a dimension in a plane parallel to the first main surface of the first substrate which is smaller than, larger than or equal to a dimension of an opening of the gas-filled cavity, thereby improving adaptation of the antenna, its radiation efficiency and the bandwidth.

According to embodiments, the antenna elements are formed from a conductive material, e.g. from a metal, such as gold, copper, titanium, nickel, palladium or molybdenum.

According to embodiments, one, more or all of the antenna elements are formed from one or more different conductive materials, wherein the more different conductive materials are arranged one above the other.

According to embodiments, the sidewall of the gas-filled cavity is inclined relative to the first main surface of the first substrate, e.g. by 90°−α, with α=0° to 10°.

According to embodiments, a thickness of the conductive layer arranged on the bottom and the side wall of the gas-filled cavity is greater than half of the skin depth at a lowest operating frequency of the antenna array.

According to embodiments, the gas-filled cavity is filled with air or air with a lower gas pressure, water vapor, nitrogen, argon, oxygen or a mixture of the gases.

According to embodiments, the conductive layer arranged on the bottom and the side wall of the gas-filled cavity comprises a metal, such as gold, copper, titanium, nickel, palladium, molybdenum.

According to embodiments, the conductive layer arranged on the bottom and the side wall of the gas-filled cavity is formed from one or more different conductive materials, wherein the more different conductive materials are arranged one above the other.

According to embodiments, the gas-filled cavity has a polygonal, round or oval shape in plan view.

According to embodiments, the antenna array comprises at least one insulating layer arranged above the second substrate.

According to embodiments, the at least one insulating layer further covers the antenna elements.

According to embodiments, the antenna array comprises a conductive excitation structure for exciting at least one of the antenna elements, the conductive excitation structure comprising:
at least one planar transmission line arranged on a main surface of the insulating layer facing away from the antenna elements, for exciting at least one of the antenna elements, or
at least one via extending through the insulating layer for exciting at least one of the antenna elements.

According to embodiments, the antenna array comprises a conductive matching structure arranged on the main surface or a main surface of the insulating layer facing away from the antenna elements, for adjusting one or more properties of the antenna array, e.g. a bandwidth.

According to embodiments, a region of the first main surface of the first substrate in which the gas-filled cavity is not formed is at least partially metallized.

According to embodiments, an interface between the first substrate and the second substrate comprises a layer made of an amorphous material.

According to embodiments, an interface between the first substrate and the second substrate is a layer of an adhesive-free interface.

According to embodiments, the first substrate has a thickness of 200 μm to 1000 μm, and wherein the second substrate has a thickness of 1 μm to 150 μm, advantageously 10 μm to 100 μm.

According to embodiments, the inorganic material for the first substrate comprises:
a semiconductor material, e.g. silicon, AlN, SiC, GaN, GaAs, or InP,
a ceramic material, e.g. a silicon nitride, low-temperature cofired ceramic, LTCC, diamond, or alumina,
single-crystalline sapphire, or
diamond.

According to embodiments, the non-conductive inorganic material for the second substrate comprises:
a quartz glass material, e.g. synthetic quartz glass (silica glass), or
a ceramic material, e.g. alumina, spinel, silicon carbide, magnesium oxide, or aluminum nitride.

According to embodiments, the first substrate has a resistivity of higher than 10 kΩcm and lower than 10 GΩcm.

According to embodiments, the second substrate has an OH concentration of higher than 0.1 ppm and lower than 10 ppm.

According to embodiments, at least one further antenna element of the plurality of antenna elements is arranged above the gas-filled cavity.

According to embodiments, all remaining antenna elements of the plurality of antenna elements are not arranged above the gas-filled cavity.

According to embodiments, all antenna elements of the plurality of antenna elements are arranged above the gas-filled cavity.

According to embodiments, the antenna array comprises at least one further gas-filled cavity formed in the first main surface of the first substrate and extending into the semiconductor substrate in the direction of the second main surface of the first substrate, wherein a further conductive layer is arranged on a bottom and a side wall of the further gas-filled cavity, wherein at least one further antenna element of the plurality of antenna elements is arranged above the further gas-filled cavity.

According to embodiments, all remaining antenna elements of the plurality of antenna elements are neither arranged above the gas-filled cavity nor above the further gas-filled cavity.

According to embodiments, the antenna array comprises at least one further gas-filled cavity formed in the first main surface of the first substrate and extending into the semiconductor substrate in the direction of the second main surface of the first substrate, wherein a further conductive layer is arranged on a bottom and a side wall of the further gas-filled cavity, wherein the at least one antenna element is arranged above the gas-filled cavity and above the further gas-filled cavity.

According to embodiments, a depth and/or shape of the gas-filled cavity and a depth and/or shape of the further gas-filled cavity are the same or different.

According to embodiments, a distance d between the gas-filled cavity and the further gas-filled cavity is given according to the following formula:

$$d > α \times t$$

wherein:
0.3≤α≤5, advantageously 0.5≤α≤1, and
a depth t of the gas-filled cavity is between 20 μm and 300 μm.

According to embodiments, an operating range of the antenna array is in a frequency range between 85 GHz and 1 THz.

According to embodiments, a total pressure in the gas-filled cavity is between 1×10⁻⁴ Pa and 5×10⁻⁵ Pa, advantageously between 1×10⁻³ Pa and 2×10⁵ Pa.

According to embodiments, the recess is not filled with a solid or liquid material before arranging the second substrate on the first main surface of the first substrate.

According to embodiments, arranging the second substrate on the first main surface of the first substrate comprises bonding such that an amorphous interface is formed between the first substrate and the second substrate.

According to embodiments, arranging the second substrate on the first main surface of the first substrate comprises connecting the first and second substrates without using an adhesive.

### BRIEF DESCRIPTION OF THE DRAWINGS

Embodiments of the present invention are explained in more detail below referring to the appended drawings, in which:

FIG. 1(A) and FIG. 1(B) show a first embodiment of an inventive antenna array;

FIG. 2(A) and FIG. 2(B) show a second embodiment of an inventive antenna array;

FIG. 3(A) and FIG. 3(B) show a third embodiment of an inventive antenna array;

FIG. 4 shows a fourth embodiment of an inventive antenna array;

FIG. 5 shows a fifth embodiment of an inventive antenna array;

FIG. 6(A) and FIG. 6(B) show a sixth embodiment of an inventive antenna array;

FIG. 7(A) to FIG. 7(C) show a seventh embodiment of an inventive antenna array;

FIG. 8(A) and FIG. 8(B) show a first embodiment of an inventive antenna array;

FIG. 9(A) and FIG. 9(B) show a ninth embodiment of an inventive antenna array;

FIG. 10(A) and FIG. 10(B) show a tenth embodiment of an inventive antenna array;

FIG. 11(A) and FIG. 11(B) show an eleventh embodiment of an inventive antenna array; and

FIG. 12 shows a flow chart of a method for producing an inventive antenna array.

### DETAILED DESCRIPTION OF THE INVENTION

In the following description of the embodiments of the present invention, equal elements or elements of equal effect are provided with the same reference numerals in the different drawings.

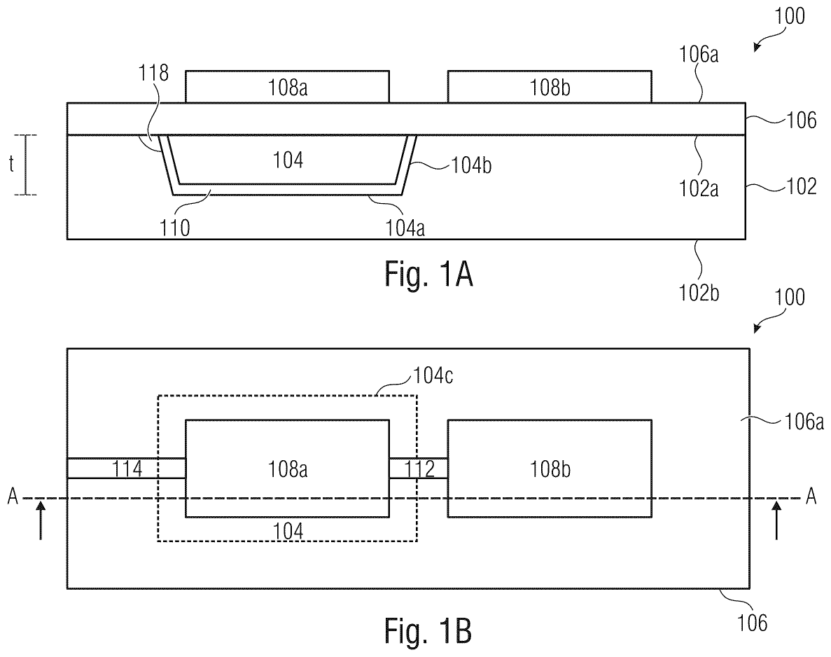

FIG. 1(A) and FIG. 1(B) show a first embodiment of an inventive antenna array 100, wherein FIG. 1(A) shows a sectional view and FIG. 1(B) shows a plan view of the antenna array 100. FIG. 1(A) shows a sectional view along the line A-A, which is shown in FIG. 1(B). The antenna array 100 comprises a first substrate 102 made of an inorganic material, a cavity 104 which is filled with at least one gas, i.e. according to embodiments the cavity is filled with only one gas, e.g. air, and according to further embodiments with two or more gases or a gas mixture of two or more gases, e.g. air with a lower gas pressure, water vapor, nitrogen, argon or oxygen. In the following, the cavity 104 is referred to as a gas-filled cavity 104 or simply as a cavity. The antenna array 100 further comprises a second substrate 106 and a plurality of antenna elements 108a and 108b. The gas-filled cavity 104 is, for example, a cavity filled with air. The cavity 104 is formed in a first main surface 102a of the first substrate 102. The cavity 104 extends from the first main surface 102a into the first substrate 102 in the direction of a second main surface 102b of the first substrate 102, which is opposite the first main surface 102a. The cavity 104 has a depth t with which it extends into the first substrate 102 without penetrating the first substrate 102. A conductive layer 110 is arranged on the bottom 104a and on the side wall 104b of the cavity 104. The second substrate 108 is made of a non-conductive inorganic material, which, as can be seen in FIG. 1(A), is arranged above the first main surface 102a of the first substrate 102. It is to be pointed out here that FIG. 1(A) shows an embodiment in which the second substrate 106 is arranged directly on the first main surface 102a of the first substrate 102. However, the present invention is not limited to such embodiments, rather, one or more further conductive layers and/or non-conductive layers can be arranged between the first substrate 102 and the second substrate 108 so that the antenna elements 108a, 108b are located on a layer stack comprising a plurality of layers, which is arranged on the main surface 102a of the first substrate 102.

The antenna elements 108a and 108b are made of a conductive material and, as shown in FIG. 1(B), are connected to each other via a conductor trace 112. Further, FIG. 1(B) shows the line 114 for supplying the signal to be emitted and for forwarding a received signal to a receiving device (not shown), to which the antenna array 100 can be connected.

As can further be seen from FIG. 1(B), the antenna element 108a has a dimension in a plane parallel to the main surface 106a of the second substrate 106, which is smaller than an opening 110c defined by the cavity 104. In other words, the antenna element 108a is spaced on all sides from the side wall 104b of the cavity 104 (in plan view along a direction perpendicular to the upper surface 106a of the second substrate 106). However, the present invention is not limited to the embodiment of the antenna element 108a shown in FIG. 1(B). Rather, the antenna element 108a can also have dimensions so that the antenna element 108a extends at least partially over the opening 104c of the cavity 104 into a region below which there is no cavity. In such embodiments, the antenna element 108a (in plan view onto the upper main surface 106a of the second substrate 106) is thus arranged to at least partially overlap with the cavity 104. In yet other embodiments, the dimension of the antenna element 108a can be larger than the opening 104c defined by the cavity 104. In yet other embodiments, the dimensions of the opening 104c and of the antenna element 108a can match.

According to further embodiments, the antenna element 108a and/or the antenna element 108b can comprise one or more slots for adjusting one or more properties of the antenna array, for example its bandwidth. Furthermore, according to embodiments, the antenna elements 108a, 108b can be formed as a patch antenna, as is shown referring to FIGS. 1(A) and 1(B). Instead of the rectangular patch antenna structure shown in FIGS. 1(A) and 1(B), other shapes may also be used, for example square shapes, shapes with more than four corners, round shapes or oval shapes, i.e. polygonal, round or oval patch antenna structures can be used. In other embodiments, the antenna elements can also comprise dipole antennas. According to embodiments, the corners of the polygonal antenna elements can be rounded.

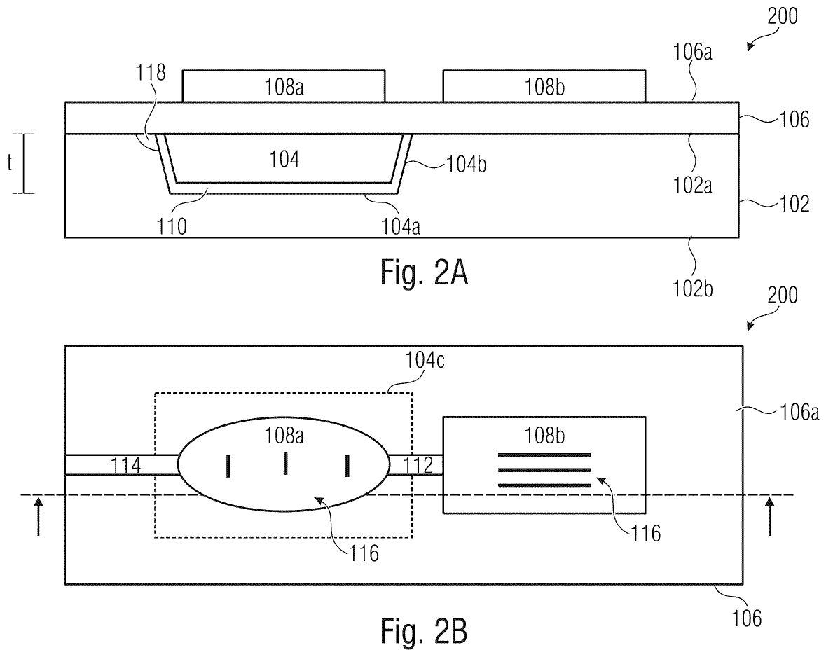

FIGS. 2(A) and 2(B) show a second embodiment of an antenna array according to the present invention. FIGS. 2(A) and 2(B) show an embodiment similar to FIGS. 1(A) and 1(B), except that the antenna elements 108a and 108b have different shapes. As can be seen from FIG. 2(B), the antenna elements are configured as patch antennas, wherein the first antenna element 108a has an oval shape, and the second antenna element 108b has a rectangular shape. Furthermore, the embodiment according to FIGS. 2(A) and 2(B) shows the above-mentioned slots 116 provided in the antenna elements 108a and 108b for adjusting one or more properties of the antenna array 200, for example its bandwidth. FIG. 2(B) shows corresponding slot structures in both antenna elements, but it is to be pointed out that the present application is not limited to such embodiments. Rather, the slots can also be provided only in one of the antenna elements. Furthermore, the shape and number of the slots are not limited to the embodiment of three horizontal and vertical slots shown in FIG. 2(B). Depending on the property to be adjusted and depending on the extent of the adjustment to be carried out, other shapes of slots and/or other numbers of slots can be used.

As mentioned above, the antenna elements 108a, 108b are advantageously formed from a conductive material, e.g. from a metal, such as gold, or from another conductive material, such as gold, copper, titanium, nickel, palladium or molybdenum. Preferably, a material with high electrical conductivity is selected, such as gold or copper. According to embodiments, one, more or all of the antenna elements are single-layered and formed from a conductive material. According to other embodiments, one, more or all of the antenna elements are multi-layered and formed from more different conductive materials which are arranged one above the other.

Referring to FIGS. 1(A) to 2(B), embodiments of the inventive antenna array 100, 200 are described, in which the sidewall 104b of the cavity 104 is inclined by an angle 118 relative to the second main surface 102a of the first substrate 102. According to embodiments, the angle 118 is 90°−α, wherein α is advantageously between 0° and 10°. In other words, the sidewall 104b of the cavity 104 is inclined relative to the main surface 102a of the first substrate 102 advantageously between 90° and 80°. An inclination of the sidewall 104b, for example by 80°, is of advantage since a larger number of resonances can form in the cavity, thereby allowing a larger bandwidth. According to embodiments, edges of the structure are rounded, e.g. the locations where the sidewall 104b of the cavity 104 and the main surface 102a of the first substrate 102 and/or the bottom 104a and the sidewall 104b of the cavity 104 abut to each other.

Referring to FIGS. 1(A) to 2(B), it has been explained that the cavity 104 is completely metallized, i.e. that a conductive layer is applied to its bottom 104a and to its sidewall 104b. The thickness of the conductive layer is advantageously more than half of the skin depth at the lowest operating frequency of the antenna array 100, 200. According to embodiments, the operating frequency of the antenna array 100, 200 is between 85 GHz and 1 THz. This embodiment is of advantage since the losses due to the lower surface roughness are smaller.

The conductive material of the layer 110 advantageously comprises a metal, for example gold, aluminum, copper, titanium, nickel, palladium or molybdenum. Preferably, a material with high electrical conductivity is selected, e.g. gold or copper. According to embodiments, the conductive layer 110 is single-layered and formed from a conductive material. According to other embodiments, the conductive layer 110 is multi-layered and formed from more different conductive materials which are arranged one above the other.

According to the embodiments described referring to FIGS. 1(A) to 2(B), the cavity 104 is filled with a gas with a gas pressure between 1×10⁻⁴ Pa and 5×10⁵ Pa, advantageously between 1×10⁻³ Pa and 2×10⁵ Pa. The specified ranges for the gas pressure result, e.g., from deviations in the uniformity of the thickness of the inorganic first substrate 102, which in turn result from the difference in the polishing pressure and the total pressure of the gas-filled cavity. Preferably, the cavity 104 is filled with air. Filling with air is of advantage since this reduces the losses of the antenna. However, the present invention is not limited to air-filled cavities; rather, the cavity 104 can also be filled with another gas, more gases or a gas mixture of two or more gases, for example air with a lower gas pressure, water vapor, nitrogen, argon or a mixture of the gases. Filling with nitrogen is of advantage, e.g., when adapting to different production processes is required.

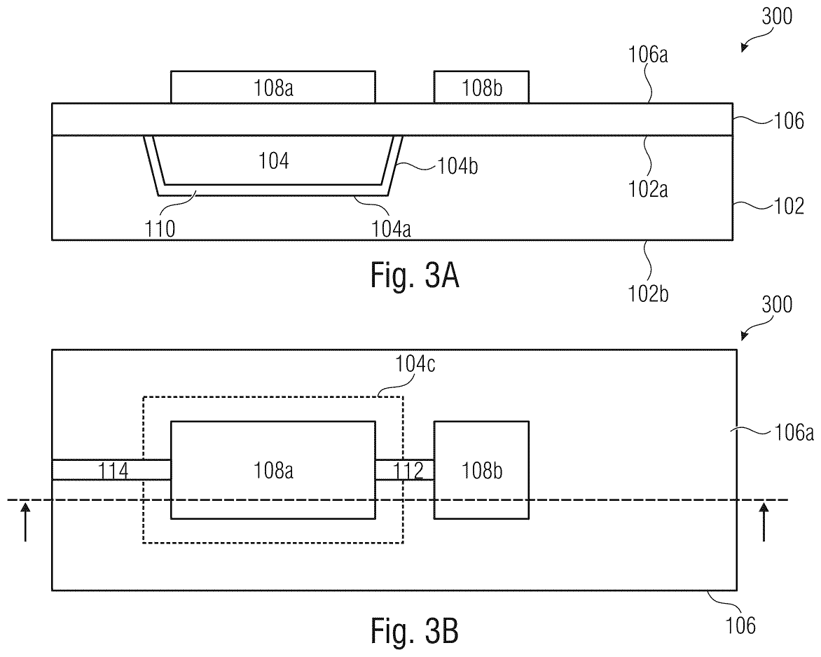

FIGS. 3(A) and 3(B) show a third embodiment of an antenna array 300 according to the present invention. The structure is similar to the structure of the antenna array 100, except that the antenna elements 108a and 108b, unlike in FIGS. 1(A) and 1(B), have different dimensions and different shapes. The antenna element 108a is formed as a rectangular patch antenna, whereas the antenna element 108b is formed as a square patch antenna. Such an embodiment is of advantage to improve the radiation properties of the antenna, such as the side lobe ratio.

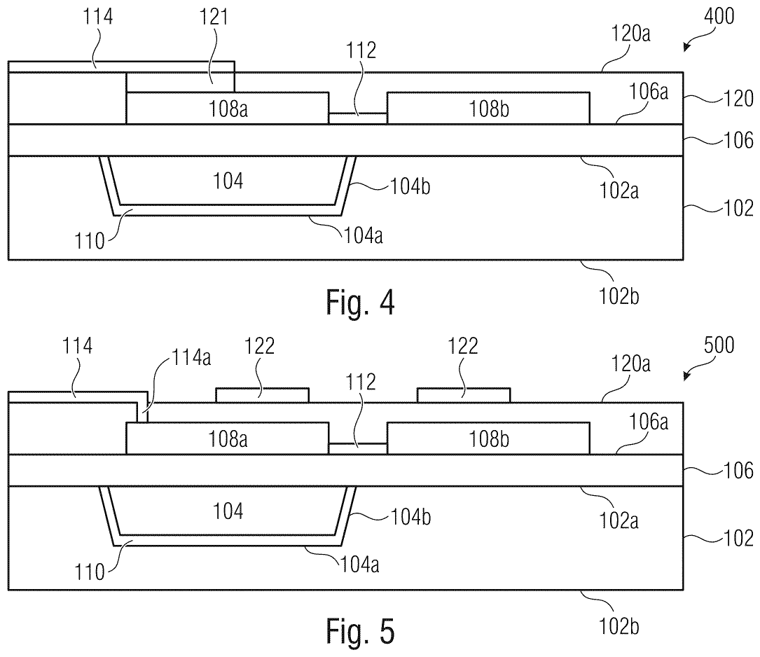

FIG. 4 shows a fourth embodiment of an antenna array 400 according to the present invention. FIG. 4 shows a setup of an antenna array similar to that of FIGS. 1(A) and 1(B), in which an insulating layer 120 is arranged on the first main surface 106a of the second substrate 100. According to embodiments, the insulating layer 120 is formed from an inorganic material and allows protection of the metal surface.

The layer 120 is arranged on the second substrate 106 such that at least the antenna elements 108a and 108b and the connection 112 thereof are covered. Unlike in the embodiments shown referring to FIGS. 1(A) to 3(B), the line 114 for supplying the antenna signal and for emitting a received signal is not arranged on the surface of the second substrate 106, but on the surface 120a of the layer 120 facing away from the second substrate 106. The conductive structure 114 is configured such that it extends at least partially over the first antenna element 108a for capacitively impressing an antenna signal into the antenna elements and for capacitively coupling a signal received via the antenna elements into the line 114. According to embodiments, an opening 121 can be provided in the overlap region of line 114 and antenna element 108a.

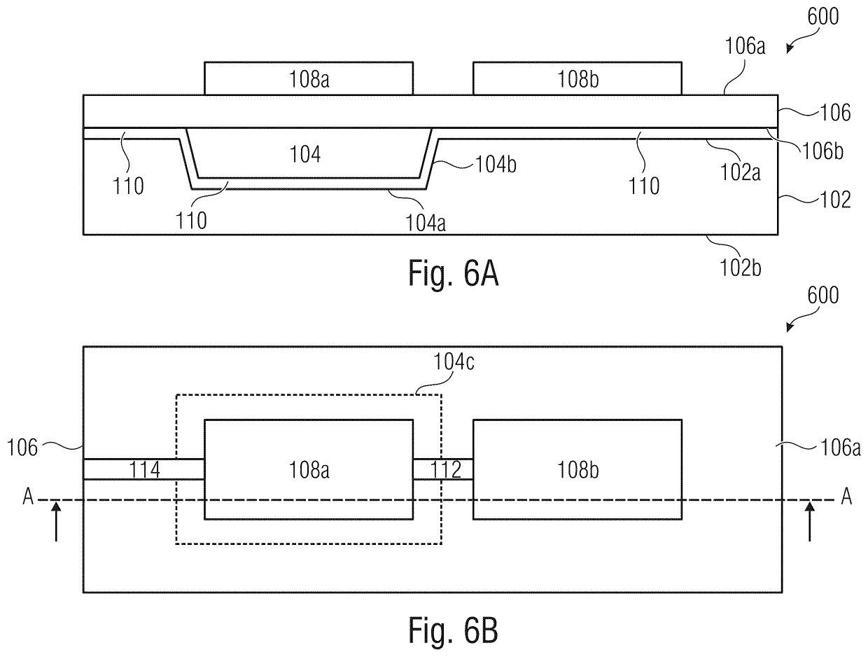

FIG. 5 shows a fifth embodiment of an antenna array 500, in which, similar to the embodiment shown referring to FIG. 4, the further insulation layer 120 is arranged on the second substrate 106. Unlike in FIG. 5, the conductor structure 114 for supplying the antenna signal and for emitting a received signal is not capacitively coupled to the first antenna element 108a, but via a through-contact or via 114a. FIG. 5 further shows an embodiment in which one or more conductive matching structures 122 are additionally provided on the main surface 120a of the insulating layer 120 facing away from the antenna elements 108a, 108b. The matching structures 122 can be made from a conductive material, for example metal, and have a shape and configuration configured for adjusting one or more properties of the antenna array, e.g. its bandwidth. It is to be pointed out here that such matching structures can also be used in the embodiment shown referring to FIG. 4.

It is further pointed out that the additional insulation layer 120 can also be used in the embodiments described referring to FIGS. 1(A) to 3(B). In this case, the layer 120 covers the line 114 in addition to the antenna elements and the connection 112 thereof. In such a case, corresponding matching structures 122 can also be provided on the upper surface 120a.

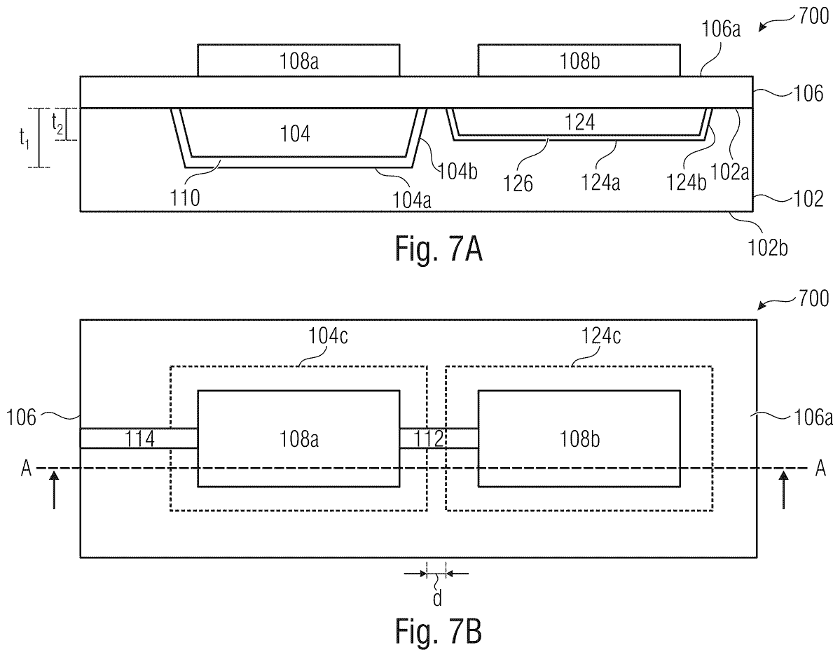

FIGS. 6(A) and 6(B) show a sixth embodiment of an antenna array 600 according to the present invention. FIGS. 6(A) and 6(B) show the setup of an antenna array similar to that of FIGS. 1(A) and 1(B), in which a region of the first main surface 102a of the first substrate 102 is additionally covered with a conductive layer. In other words, in the embodiment shown referring to FIGS. 6(A) and 6(B), a region of the first main surface of the first substrate in which the cavity 104 is not filled is covered completely with the conductive layer 110. The present invention is not limited to this embodiment; rather, the region of the main surface 102a in which the gas-filled cavity 104 is not formed can also be only partially metallized. The additional metallization of the surface 102a, i.e. in addition to lining the cavity 104 with the conductive layer 110, is of advantage, for example, to improve the antenna properties, such as the bandwidth and the polarization.

In the embodiments described referring to FIGS. 1(A) to 6(B), the first substrate 102 and the second substrate 106 are advantageously connected to each other by bonding such that a layer made of an amorphous material is formed at the interface between the first substrate and the second substrate, i.e. at the location where the first main surface 102a and the second main surface 106b (see FIG. 6(A)) meet. In other words, the substrates 102, 106 are connected without additional connecting material, such as an adhesive.

According to embodiments, the first substrate has a thickness of 200 μm to 1000 μm, and the second substrate has a thickness of 1 μm to 150 μm, advantageously 10 μm to 100 μm. This allows a high mechanical stability and the optimization of the radiation properties of the antenna, in particular the efficiency.

The inorganic material of the first substrate 102 comprises, for example:
a semiconductor material, e.g. silicon, AlN, SiC, GaN, GaAs, or InP, or
a ceramic material, e.g. a silicon nitride, low-temperature cofired ceramic, LTCC, diamond, or alumina, or
single-crystalline sapphire, or
diamond.

The non-conductive inorganic material of the second substrate 106 comprises, for example:
a quartz glass material, e.g. synthetic quartz glass (silica glass), or
a ceramic material, e.g. alumina, spinel, silicon carbide, magnesium oxide, or aluminum nitride.

An advantageous material combination consists of silicon for the first substrate 102 and quartz glass for the second substrate 106 since they allow high production accuracy, low losses of the antennas, high thermal conductivity, and high mechanical stability.

According to embodiments, the first substrate 102 has a resistivity of higher than 10 kΩcm and lower than 10 GΩcm. According to embodiments, the second substrate 106 has an OH concentration of higher than 0.1 ppm and lower than 10 ppm.

The previously described embodiments of the inventive antenna array comprise a cavity as well as two antenna elements. It is to be pointed out here that the present invention is not limited to this implementation. Rather, more cavities and/or more than two antenna elements can be provided. In the following, further embodiments of the present invention are explained, more precisely further embodiments based on the antenna array 100 shown referring to FIGS. 1(A) and 1(B). It is to be pointed out here that, of course, the further embodiments shown referring to FIGS. 2(A) to 6(B) can also be used in connection with the further embodiments described below.

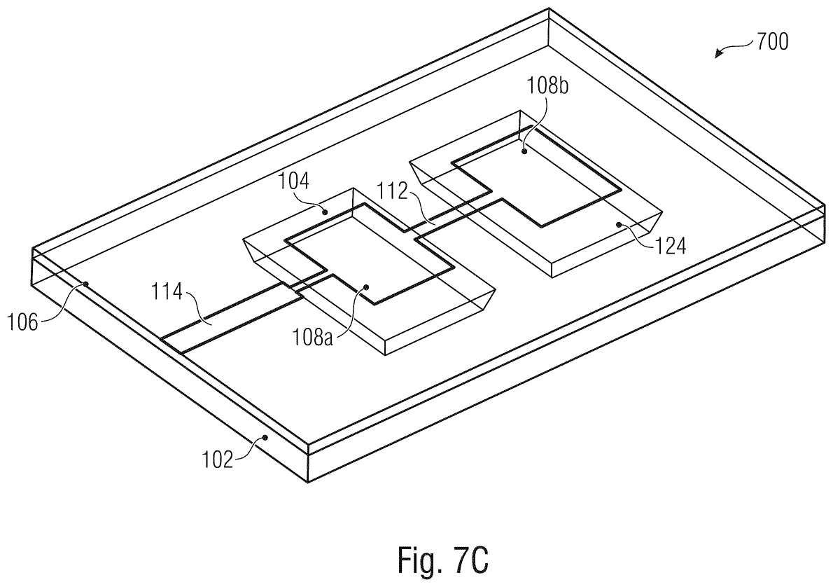

FIGS. 7(A) to 7(C) show a seventh embodiment of an antenna array 700 comprising more than one cavity 104. FIG. 7(C) shows an isometric representation of the antenna array 700. FIGS. 7(A) to 7(C) show an antenna array 700 in which, in addition to the gas-filled cavity 104 below the antenna element 108a, a further gas-filled cavity 124 is arranged below the second antenna element 108b. A conductive layer 126 is arranged on the bottom 124a and on the side wall 124b of the further cavity 124, similar to the cavity 104, which can be formed from the same material or from a different material than the layer 110. The cavity 124 is filled with a gas, e.g. air, or with two or more gases or with a gas mixture of two or more gases, for example with air and/or with another gas. The cavities 104, 124 may also be filled with different gases.

In the embodiment shown in FIGS. 7(A) to 7(C), the cavities 104, 124 have different depths t1 and t2, which is of advantage to optimize the radiation properties of the antennas. According to other embodiments, the further cavity 124 can be deeper than the cavity 104, and in yet other embodiments, the cavities 104, 124 can have the same depth. The depth of the cavity influences the efficiency and the adaptation of the individual antenna elements so that the antenna properties can be advantageously influenced by different depths of the cavities.

In addition to the different depths t1, t2, the openings 104, 124 can also have other, possibly different shapes, for example round or oval shapes. For example, one of the openings can be oval or round, and the other can be rectangular or square. According to embodiments, the cavities 104, 124 have a distance d between 100 μm and 1000 μm. Preferably, the distance is selected as follows: the antenna elements with the cavities have a center distance of half a wavelength so that the radiation of individual antennas overlaps advantageously. According to embodiments, the distance d between the gas-filled cavity 104 and the further gas-filled cavity 124 is given according to the following formula:

$$d > α \times t$$

wherein:
α is between 0.3 and 5, advantageously between 0.3 and 1, and
a depth t of the gas-filled cavity is between 20 μm and 300 μm.

As already mentioned above, the present invention is not limited to embodiments of the antenna array with only two antenna elements. According to other embodiments, a plurality of antenna elements of the same or different shape can be provided, of which at least one antenna element is arranged above a gas-filled cavity. According to other embodiments, one, more or all of the antenna elements can also be arranged above a common cavity.

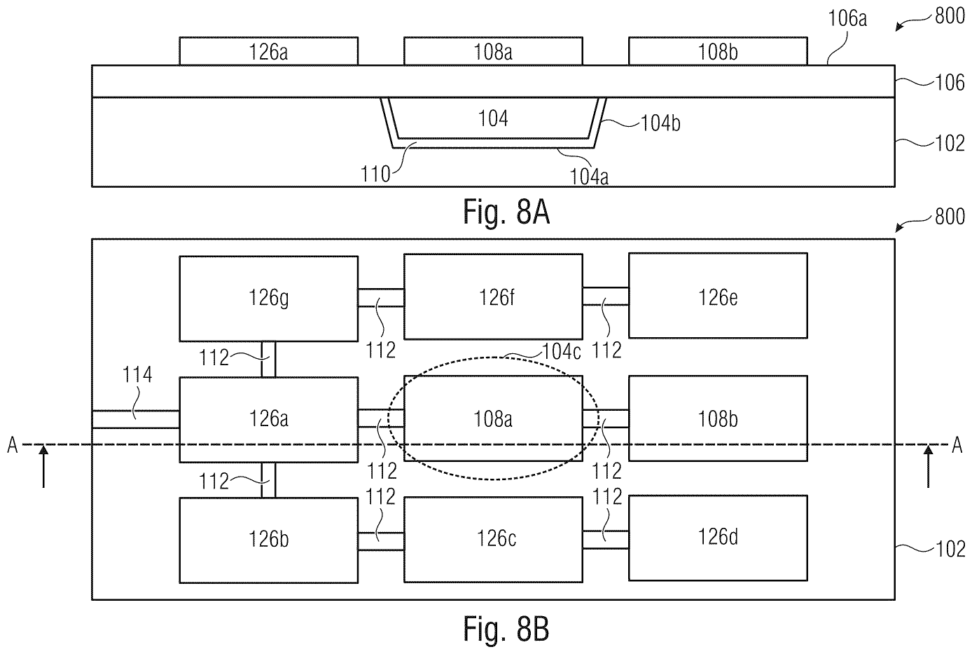

FIGS. 8(A) and 8(B) show an eighth embodiment of an antenna array 800 of the present invention, in which, based on the embodiment described referring to FIGS. 1(A) and 1(B), a plurality of further antenna elements 126a to 126g are arranged on the main surface 106a of the second substrate facing away from the first substrate 102, as can be seen in particular from FIG. 8(B). The antenna elements are connected to one another by the connections 112, and the supply of the antenna signal and the emission of the received signal are effected via the line 114. In the embodiment shown in FIGS. 8(A) and 8(B), the antenna array 800 comprises a cavity 104 which, as can be seen from FIG. 8(B), has an oval shape, unlike in the other embodiments. The at least one antenna element 108a is arranged above the cavity 104 such that the corners thereof are arranged outside the opening 104c. In the embodiment shown in FIGS. 8(A) and 8(B), all of the antenna elements, except for the antenna element 108a, are arranged in regions in which no cavity is provided in the first substrate 102.

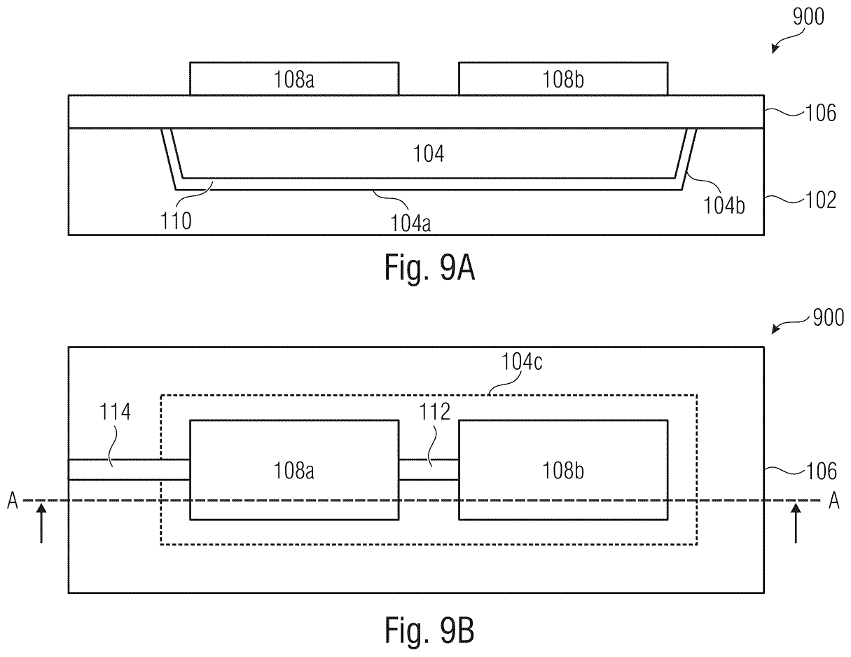

FIGS. 9(A) and 9(B) show a ninth embodiment of an antenna array 900 of the present invention, in which the two antenna elements are arranged above a common cavity. FIGS. 9(A) and 9(B) show an embodiment similar to FIGS. 1(A) and 1(B), wherein the gas-filled cavity 104, however, is configured such that it extends both under the first antenna element 108a and under the second antenna element 108b. The arrangement of the antenna elements above a common cavity 104 is of advantage since this allows production with low tolerances.

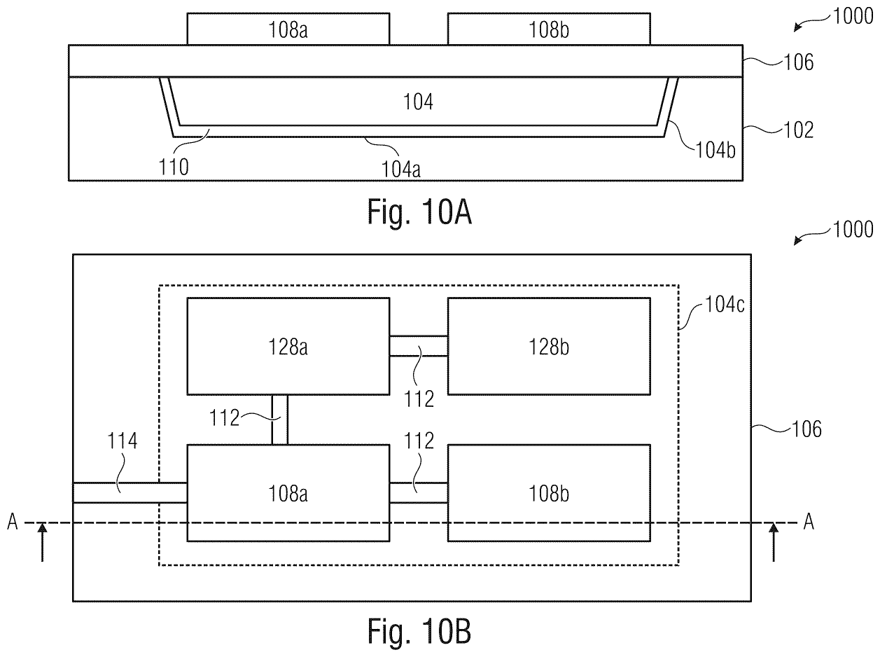

FIGS. 10(A) and 10(B) show a tenth embodiment of an antenna array 1000 according to the present invention, in which more than two antenna elements are provided, which are all arranged above a common opening, similar to FIGS. 9(A) and 9(B). Based on the embodiment according to FIGS. 9(A) and 9(B), the antenna array 1000 comprises two further antenna elements 128a, 128b, which are connected to the first antenna element 108a by the conductive connections 112. As can be seen from FIG. 10(B), all of the antenna elements of the antenna array 1000 are arranged above the opening 104c of the gas-filled cavity 104.

In the embodiments shown referring to FIGS. 9(A) to 10(B), thus, in addition to the at least one antenna element 108a, all other remaining antenna elements of the plurality of antenna elements are also arranged above the gas-filled cavity.

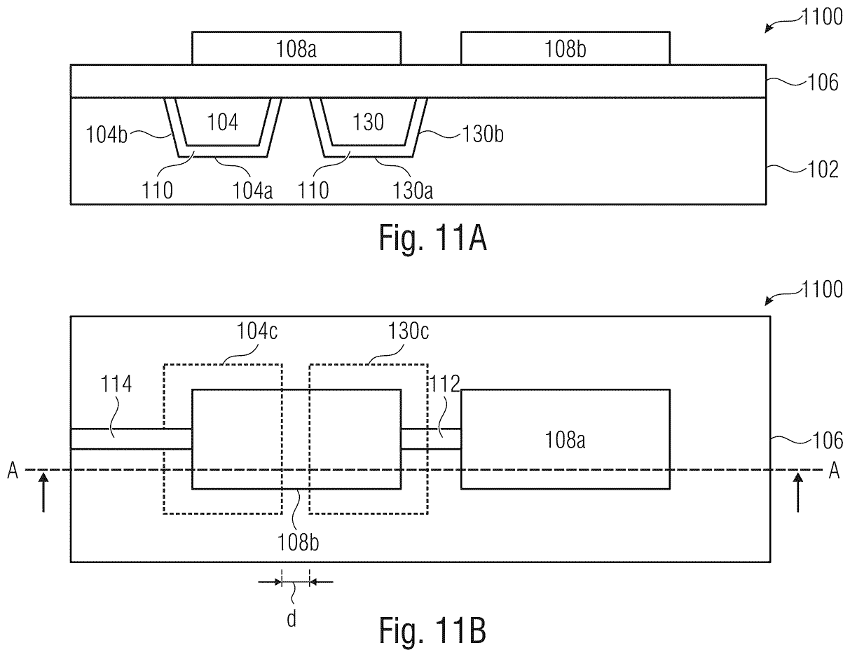

In the previously described embodiments of the inventive antenna array, at least one of the antenna elements, for example the antenna element 108a, was arranged above a cavity 104. However, the present invention is not limited to such embodiments. Rather, more cavities can also be provided, above which an antenna element is located. FIGS. 11(A) and 11(B) show an eleventh embodiment of an antenna array 1100 according to the present invention. FIG. 11(A) shows an embodiment in which, in addition to the cavity 104, a further cavity 130, i.e. a further gas-filled or air-filled cavity, is provided, which are spaced from each other by a distance d. The distance d is selected between 100 μm and 2000 μm to allow a center distance of the individual antenna elements of half a wavelength so that the radiation of the individual elements overlaps advantageously. The at least one antenna element 108a is arranged on the second substrate 106 such that it is arranged both above the cavity 104 and above the cavity 130. This implementation is of advantage to optimize the antenna properties, such as the bandwidth and the polarization. Here, too, according to embodiments, the distance d between the gas-filled cavity 104 and the further gas-filled cavity 124 can be given according to the following formula:

$$d > α \times t$$

wherein:
α is between 0.3 and 5, advantageously between 0.3 and 1, and
a depth t of the gas-filled cavity is between 20 μm and 300 μm.

FIGS. 11(A) and 11(B) show an embodiment in which the two cavities 104, 130 have the same dimensions and shapes. It is to be pointed out here that the present invention is not limited to such implementations. The cavities can have different shapes, for example one of the cavities can be implemented to be oval or round and the other can be implemented to be rectangular, and also the depths of the cavities can be the same or different.

The gas-filled cavity may also be described as not penetrating through the first substrate. In other words, the gas-filled cavity may be described as not reaching the second main surface of the first substrate. A depth t of the gas-filled cavity can be smaller than a depth/height of the first substrate in the direction of the second main surface of the first substrate.

Referring to FIGS. 1(A) to 11(B), different embodiments of the inventive antenna array have been explained in more detail. FIGS. 1(A) and 1(B) show the basic structure of the inventive antenna array with at least two antenna elements, at least one of which is arranged above a gas-filled or air-filled cavity, the inside of which, i.e. the side wall and bottom of which, is covered with a conductive material. For a person skilled in the art, it is obvious that the different implementations described referring to FIGS. 1(A) to 11(B) can be combined with one another so that according to the invention also embodiments of the antenna array are taught which consist of a combination of the different features of the embodiments described above, without these being explicitly shown.

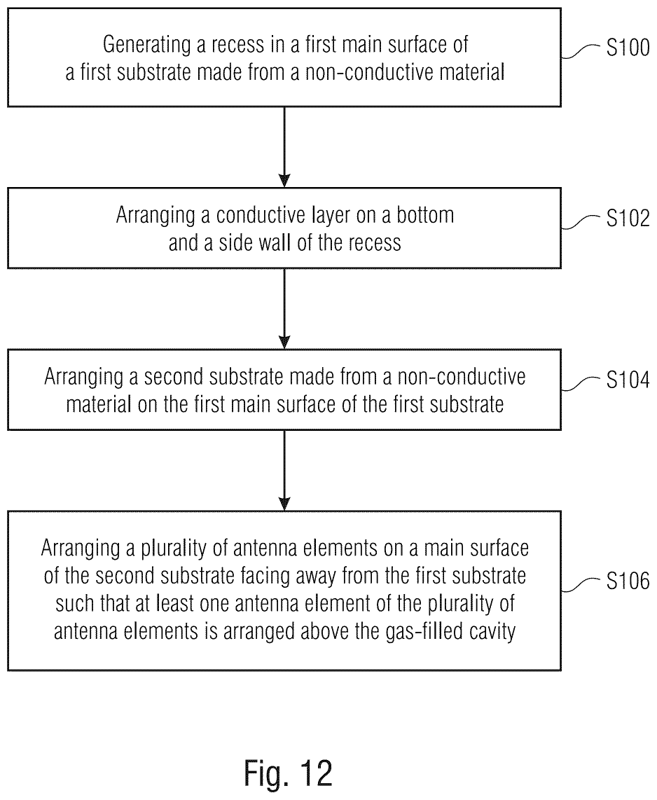

The present invention further provides a method for producing an antenna array, and FIG. 12 shows a flow chart of such a production method. In step S100, a recess is generated in a first main surface of a first substrate made of an inorganic material. The recess is generated such that it extends into the first substrate starting from the first main surface in the direction of a second main surface of the first substrate, which is opposite the first main surface, without penetrating the first substrate. In step S102, a conductive layer is arranged on a bottom on a side wall of the recess generated in the first substrate. In step S104, a second substrate made of a non-conductive inorganic material is arranged on the first main surface of the first substrate, i.e. such that the recess generated in the first substrate is covered so that a closed gaseous cavity results. In step S104, a plurality of antenna elements is generated on a main surface of the second substrate facing away from the first substrate, i.e. such that at least one of the antenna elements is arranged above the gas-filled cavity.

According to further embodiments, it may be provided to fill the recess with a gaseous material before arranging the second substrate on the first main surface of the first substrate, e.g. with one or more gases or with a gas mixture of two or more gases. The gaseous material can comprise air or another gas, for example air with a lower gas pressure, water vapor, nitrogen, argon, oxygen or a mixture of the gases. If an air-filled cavity or an air-filled cavity is desired, no additional production steps are required; when introducing a certain gas, corresponding further method steps are required, for example producing in a corresponding environment.

According to embodiments, step S104 comprises bonding the second substrate to the first main surface of the first substrate, advantageously such that an amorphous interface is formed between the first substrate and the second substrate and thus an adhesive-free connection is formed between the substrates.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] “Embedded air cavity backed microstrip antenna on an LTCC substrate”, M. Komulainen et. al., “Embedded air cavity backed microstrip antenna on an LTCC substrate”, 2006, Elsevier
[2] A. Panther et. al., “A Wideband Array of Stacked Patch Antennas Using Embedded Air Cavities in LTCC”, 2005, IEEE
[3] V. K. Singh, “Ka-band micromachined microstrip patch antenna”, 2008, IETDL
[4] Ioannis Papapolymerou et. al., “Micromachined Patch Antennas”, 1988, IEEE
[5] Elmezughiet. al., “Backed Hi-lo Stacked Patch Antennas”, 2008, IEEE
[6] F. J. Wang et al., “WIDE BAND CAVITY-BACKED PATCH ANTENNA FOR PCS/IMI2000/2.4 GHZ WLAN”, 2007, PIER 74
[7] Xiaocheng Wang et al., “A Broadband D-Band Cavity-Backed Coupled-Feed Patch Antenna in Wafer Level Package”, 2022, IEEE
[8] Xiaocheng Wang et al., “Broadband D-Band Patch Antenna Array in Wafer-Level Package Based on BCB Process”, 2022, IEEE
[9] Chen-Pang Chao et al., “A Series-fed Cavity-back Patch Array Antenna for a Miniaturized 77 GHz Radar Module”, 2019, IEEE
[10] Junjie Xuet. al., 2022, “Design of microstrip patch antenna element and array on quartz glass wafer with suspended cavity based on MEMS technology”, Springer
[11] Kyu Kong et. al., “Broadband Modified Proximity Coupled Patch Antenna with Cavity-Backed Configuration”, 2022, JEES
[12] Jumril Yunas et al., “Design and Fabrication of Glass based MEMS Patch Antenna for Energy Harvester”, 2020, IEEE
[13] H. Zhao, Q. Wang, B. Wen, Y. Yang, Wen Yue, W Wang, “Glass-based Microstrip Antenna with Air Cavity for High Gain”, 23rd. ICEPT, 2022
[14] S. Mortazavi, A. S. Esfahani, A. Hamidian, A. Malignaggi, H. H. Abdullah, G. Boeck, “Broadband Cavity-Backed Antenna Arrays on Glass Substrate for 60 GHz Application”, 44th European Microwave Conference, 2014
[15] J. Xu, S. Lin, Y Huang, Z. Wang, “Design of Patch Antenna Array with Cavity Structure on Quartz Glass for Radar Applications”, 44th European Microwave Conference, 2022, 9th Symposium on Microwave, Antenna, Propagation and EMC Technologies for Wireless Communications
[16] J. Zhang, G. Yang, T Ma, W Jiang, “A Wideband SIW-Fed Cavity-Backed Antenna for W-Band Applications”, Nanjing Research Institute of Electronic Technology National Key Laboratory of Antenna and Microwave Technology, 2022 International Conference on Microwave and Millimeter Wave Technology (ICMMT)
[17] J. Hu, Y U, S. Wang, Z. Zhang, “Millimeter-Wave Air-Filled Slot Antenna With Conical Beam Based on Bulk Silicon MEMS Technology”, IEEE TRANSACTIONS ON ANTENNAS AND PROPAGATION, VOL. 68, NO. 5, May 2020
[18] Yaxiang Wu, Tian Yu, Miao Zhang, Daquan Yu, Jiro Hirokawa, Qing Huo Liu, “A W-Band Corporate-Fed Hollow-Waveguide Slot Array Antenna by Glass Micromachining”, Proceedings of ISAP2020, Osaka, Japan
[19] Bo Pan, Y. Yoon, J. Papapolymerou, M. M. Tentzeris and M. G. Allen, “A high performance surface-micromachined elevated patch antenna”, 2005 IEEE Antennas and Propagation Society International Symposium, Washington, DC, USA, 2005, pp. 397-400 vol. 18, doi: 10.1109/APS.2005.1551575.
[20] L. Valenziano, E. Bekker, V. Issakov, T. Zwick, A. Bhutani, “A 135 GHz Aperture-Coupled Antenna for D2D Communication Using Fused Silica and eWLB Technology”, Proceedings of the 54th European Microwave Conference, 2024

1. An antenna array comprising:
a first substrate made of an inorganic material,
a gas-filled cavity formed in a first main surface of the first substrate and extending into the first substrate in the direction of a second main surface of the first substrate, which is opposite the first main surface, wherein a conductive layer is arranged on a bottom and a side wall of the gas-filled cavity,
a second substrate made of a non-conductive inorganic material, which is arranged above the first main surface of the first substrate, and
a plurality of antenna elements arranged on a main surface of the second substrate facing away from the first substrate such that at least one antenna element of the plurality of antenna elements is arranged above the gas-filled cavity.

2. The antenna array according to claim 1, wherein one or more antenna elements comprise one or more slots for adjusting one or more properties of the antenna array, e.g. a bandwidth.

3. The antenna array according to claim 1, wherein the antenna elements are each formed by a conductive structure comprising a same or different shape and/or dimension.

4. (canceled)

5. The antenna array according to claim 1, wherein the at least one antenna element is configured such that the at least one antenna element and the gas-filled cavity overlap at least partially in plan view.

6. The antenna array according to claim 5, wherein at least one antenna element comprises a dimension in a plane parallel to the first main surface of the first substrate which is smaller than, larger than or equal to a dimension of an opening of the gas-filled cavity, thereby improving adaptation of the antenna, its radiation efficiency and the bandwidth.

7-9. (canceled)

10. The antenna array according to claim 1, wherein a thickness of the conductive layer arranged on the bottom and the side wall of the gas-filled cavity is greater than half of the skin depth at a lowest operating frequency of the antenna array.

11-14. (canceled)

15. The antenna array according to claim 1, comprising at least one insulating layer arranged above the second substrate.

16. The antenna array according to claim 15, wherein the at least one insulating layer further covers the antenna elements.

17. The antenna array according to claim 15, comprising a conductive excitation structure for exciting at least one of the antenna elements, the conductive excitation structure comprising:
at least one planar transmission line arranged on a main surface of the insulating layer facing away from the antenna elements, for exciting at least one of the antenna elements, or
at least one via extending through the insulating layer for exciting at least one of the antenna elements.

18-21. (canceled)

22. The antenna array according to claim 1, wherein the first substrate comprises a thickness of 200 μm to 1000 μm, and wherein the second substrate comprises a thickness of 1 μm to 150 μm, advantageously 10 μm to 100 μm.

23. (canceled)

24. The antenna array according to claim 1, wherein the non-conductive inorganic material for the second substrate comprises:
a quartz glass material, e.g. synthetic quartz glass (silica glass), or
a ceramic material, e.g. alumina, spinel, silicon carbide, magnesium oxide, or aluminum nitride.

25. (canceled)

26. The antenna array according to claim 1, wherein the second substrate comprises an OH concentration of higher than 0.1 ppm and lower than 10 ppm.

27. The antenna array according to claim 1, wherein at least one further antenna element of the plurality of antenna elements is arranged above the gas-filled cavity.

28. The antenna array according to claim 1, wherein all remaining antenna elements of the plurality of antenna elements are not arranged above the gas-filled cavity.

29. The antenna array according to claim 1, wherein all antenna elements of the plurality of antenna elements are arranged above the gas-filled cavity.

30. The antenna array according to claim 1, comprising
at least one further gas-filled cavity formed in the first main surface of the first substrate and extending into the semiconductor substrate in the direction of the second main surface of the first substrate, wherein a further conductive layer is arranged on a bottom and a side wall of the further gas-filled cavity,
wherein at least one further antenna element of the plurality of antenna elements is arranged above the further gas-filled cavity.

31. The antenna array according to claim 30, wherein all remaining antenna elements of the plurality of antenna elements are neither arranged above the gas-filled cavity nor above the further gas-filled cavity.

32. The antenna array according to claim 1, comprising
at least one further gas-filled cavity formed in the first main surface of the first substrate and extending into the semiconductor substrate in the direction of the second main surface of the first substrate, wherein a further conductive layer is arranged on a bottom and a side wall of the further gas-filled cavity,
wherein the at least one antenna element is arranged above the gas-filled cavity and above the further gas-filled cavity.

33. (canceled)

34. The antenna array according to claim 30, wherein a distance d between the gas-filled cavity and the further gas-filled cavity is given according to the following formula:
d>α×t
wherein:
0.3≤α≤5, advantageously 0.5≤α≤1, and
a depth t of the gas-filled cavity is between 20 μm and 300 μm.

35-36. (canceled)

37. The antenna array according to claim 1, wherein a depth t of the gas-filled cavity is smaller than a height of the first substrate in the direction of the second main surface of the first substrate.

38. A method for producing an antenna array, comprising:
generating a recess in a first main surface of a first substrate made of a non-conductive material so that the recess extends into the first substrate in the direction of a second main surface of the first substrate, which is opposite the first main surface,
arranging a conductive layer on a bottom and a side wall of the recess,
arranging a second substrate made of a non-conductive material on the first main surface of the first substrate so that the recess is covered and a closed gas-filled cavity is generated, and
arranging a plurality of antenna elements on a main surface of the second substrate facing away from the first substrate such that at least one antenna element of the plurality of antenna elements is arranged above the gas-filled cavity.

39. The method according to claim 38, wherein the recess is not filled with a solid or liquid material before arranging the second substrate on the first main surface of the first substrate.

40. The method according to claim 38, wherein arranging the second substrate on the first main surface of the first substrate comprises bonding such that an amorphous interface is formed between the first substrate and the second substrate.

41. The method according to claim 38, wherein arranging the second substrate on the first main surface of the first substrate comprises connecting the first and second substrates without using an adhesive.
